(19) United States
(12) Patent Application Publication
(10) Pub. No.: US 2021/0064023 A1
(43) Pub. Date: Mar. 4, 2021

(54) METHOD, DEVICE AND SYSTEM FOR MANAGING A FLEED OF INFORMATION CARRIER VEHICLES

(71) Applicant: VITIROVER, Saint-Emilion (FR)

(72) Inventor: Xavier DAVID BEAULIEU, Saint-Emilion (FR)

(73) Assignee: VITIROVER, Saint-Emilion (FR)

(21) Appl. No.: 17/046,080

(22) PCT Filed: Apr. 9, 2019
(86) PCT No.: PCT/EP2019/058940

§ 371 Date: Oct. 8, 2020

(30) Foreign Application Priority Data
Apr. 9, 2018 (EP) PCT/EP2018/058986

(51) Int. Cl. G05D 1/00; G05D 1/02; G08G 1/00; G06N 3/08

(52) U.S. Cl. CPC G05D 1/0027; G05D 1/0291; G05D 2201/0213; G08G 1/20; G06N 3/08; G05D 1/0022

(57) ABSTRACT

A method of managing a fleet of information carrier vehicles is provided with each of the vehicles being autonomous in energy and arranged to move and roll on a ground of a field. Each of the information carrier vehicles includes a data communicator for communicating data to a communicating access point common to the fleet of information carrier vehicles, and a tool for performing a work. The method includes, at vehicle level: generation of data of interest, optionally locally preprocessing of data of interest, recording data of interest or pre-processed, transmission of recorded data, movement commands reception and applying the received movement commands. The method includes, at a remote processing device for the vehicles: processing received data to determine a strategy for controlling the vehicle fleet, and communication to the fleet vehicles of movement commands determined from the driving strategy.

### CROSS-REFERENCE TO RELATED APPLICATIONS

This application is a National Phase Entry of International Patent Application No. PCT/EP2019/058940, filed on Apr. 9, 2019, which claims priority to PCT/EP2018/058986, filed on Apr. 9, 2018, both of which are incorporated by reference herein.

### TECHNICAL FIELD

The invention relates to the processing of data from autonomous robots. More precisely, the invention relates to a device for processing data from autonomous robots being arranged to move on an area of interest and comprising a plurality of wheels each powered by an electric machine and at least one tool powered by an electric machine data. The invention also relates to a system and a method for processing such data.

### BACKGROUND

Methods for processing data from autonomous robots being arranged to move on an area of interest and comprising a plurality of wheels each powered by an electric machine and at least one tool powered by an electric machine data are known. For example, the “Neato robots Botvac connected” are robot vacuum cleaners. Processing the position of such a robot may be used to draw a map of a room which has been cleaned by the said robot. The position might be sent by an accelerometer module which is at the robot and processed by a processing unit. However, such a map which shows the trajectory of the robot cannot be used to infer the amount of dirtiness of the room before the robot's cleaning.

### SUMMARY

An object of the invention is, in particular, to remedy all or part of the aforementioned disadvantages. To this effect, the invention relates, according to a first aspect of the invention, to a method of managing a fleet of information carrier vehicles, each of the vehicles being autonomous in energy and arranged to move and roll on a ground of a field, each of said information carrier vehicles comprising data communication means for communicating data to a communicating access point (300) common to said fleet of information carrier vehicles and a tool (5; 5′) for performing a work, said method comprising the following steps:
at vehicle level: generation of data of interest, optional step of local preprocessing of data of interest, step of recording data of interest or pre-processed, transmission of recorded data, movement commands reception and applying the received movement commands,
at a remote processing device for the vehicles: processing received data to determine a strategy for controlling the vehicle fleet, communication to the fleet vehicles of movement commands determined from said driving strategy.

According to further non-limitative features of the invention, either taken alone or in all technically feasible combinations:
the optional preprocessing step includes a step of associating a time stamp and a location with the data of interest;
the data of interest are generated by data generating means associated with the working tool;
the data of interest is generated from at least one element of the group that follows: power consumption capture device, image capture device, meteorological data capture device, hygrometry data capture device, sunshine capture device, device for capturing aeraulic data, soil resistivity data capture device, insect population counting device, early warning device of disease obstacle detection device on the ground;
the method further comprises, at the level of the vehicles, a device for sampling the air surrounding the vehicle;
the device is a device remote from the vehicle, the vehicle further comprising data communication means configured to receive data generated by said device;
the optional preprocessing step includes a step of aggregating data of interest;
the step of transmitting data of interest or pretreated is performed synchronously, asynchronously, or triggering an event local or external to the vehicle;
the vehicles comprise storage means of the terrain topology;
the stored topology is a complete topology of the field or partial topology of the field;
the method further comprises a step of receiving, at the vehicle level, one or more updates of the topology the vehicles;
the method further comprises a step of receiving data from at least one other device;
the method further comprises an aggregation of received data to build profiles associated with a particular area of the field;
the method further comprises a predetermination of a partition of the terrain into a plurality of sub-parcels, each of the sub-parcels being provided with an indicator determined from a quantity of energy consumed by the tool of the vehicle on said sub-parcel and by a time elapsed on said sub-parcel by the vehicle;
the method further comprises an implementation of neural networks optimizing the functions and trajectories of the robot from historical data;
the method further comprises a step of calculating, for each of the vehicles, an objective point, the said objective point being calculated by using the data of interest and/or actual geographic position of the vehicle;
the method further comprises a determination of a moving strategy, by the vehicle, from a map of workload density which is computed at the remote processing device.

According to a further aspect of the invention, a system comprising a fleet of vehicles and a server is provided, the system being arranged for the implementation of a method according to the previous aspect of the invention. According to a further aspect of the invention, it is provided a server for a system according to the previous aspect.

According to a further aspect of the invention, it is provided a device for analyzing data provided by a robot of at least one energy autonomous robot, the robot being arranged to move on an area of interest and comprising a plurality of wheels each powered by an electric machine and at least one tool powered by an electric machine, comprising:
acquiring means associated to a machine of the said at least one electric machine, located at the said robot, for acquiring at least one item of information, corresponding to the power supply of the said machine;
processing means configured for interpreting the said at least one acquired information.

According to this description, an energy autonomous robot is a robot which comprises a battery such that robot may be moved without being wired to a plug. The area of interest may be a room of a home or a garden, for example. The tool may be a camera module, a suction module of a vacuum cleaner or a cutting module, such as a grass mowing module.

By acquiring means, this description preferably relates to a sensor: photo or video, weather, GPS, gyroscope, magnetometer, accelerometer, IMU inertial unit, infrared rangefinder, voltmeter, ammeter, temperature robot, pressure sensor, microphone, capacitive contact. The robot comprises means for transmitting data between the external sensor and the robot. By processing means, this description preferably relates to a processing unit, as a microprocessor.

A robot may comprise a device that is capable of receiving information from GPS satellites and then to calculate the device's geographical position, such as a GPS or GNSS module. The processing means may associate a position of the robot and at least one item of information. According to an embodiment of the invention, the processing means are configured for interpreting at least two items of information corresponding to the power supply of two of the at least one electric machine.

Preferably, each of the machine is associated to acquiring means for acquiring at least one item of information, corresponding to the power supply of said machine. According to an embodiment of the invention, the acquiring means are arranged to acquire the said at least one item of information at a frequency greater than 10 Hz. According to an embodiment of the invention, the machine may comprise an asynchronous motor and the at least one item of information corresponds to the current absorbed by the said machine.

According to an embodiment of the invention, the machine comprises a stepper motor and the at least one item of information corresponds to the motor phase control signals. On a first alternative of the invention, the processing means may be located at the robot. On another alternative of the invention, the processing means may be located remotely from the robot and the said device further may comprise transmitting means for transmitting the said at least one information, from said robot to the said processing means.

According to a second aspect of the invention, it is provided a system comprising:
a robot of at least one energy autonomous robot being arranged to move on an area of interest and comprising a plurality of wheels each powered by an electric machine and at least one tool powered by an electric machine,
a device according to the first aspect of the invention, or one or several of its improvements.

Preferably, the at least one energy autonomous robot comprises a cutting module, the tool of the device being the said cutting module. According to a third aspect of the invention, it is provided a method for analyzing data provided by a robot of at least one energy autonomous robot, the robot being arranged to move on an area of interest and comprising a plurality of wheels each powered by an electric machine and at least one tool controlled by an electric machine, a step of acquiring, by acquiring means associated to a machine of the said at least one electric machine, located at the said robot, for acquiring at least one item of information, corresponding to the power supply of the said machine, a step of interpreting, by processing means, the said at least one acquired information.

The method may comprise a step of creating a map of the area of interest from the interpreted information and a position of the robot corresponding to the position of the robot on the area of interest where the at least one item of information has been acquired. According to an embodiment of the method, the processing means may be remote from the robot, and the said method may further comprise a step of transmitting the said at least one information from the said robot to the said processing means. Transmitting the said at least one information may be done by connecting the processing means of the robot to a device of transmission, such as a phone or such as a wireless emitter. The wireless emitter may be a Wifi emitter, a Bluetooth emitter, a BLE (for Bluetooth Low Energy) emitter or a Sigfox emitter, for example.

The robot may be equipped with a filtering module such that only significant changes of the said information are sent by the transmitting step. Significant change may be defined by using a threshold. The robot may be equipped with storage means, such as an SSD card, to store the information before possibly filtering or transmitting it. Before reaching the processing means, the information may be stored in a cloud server.

In an embodiment, the at least one energy autonomous robots are at least two energy-autonomous robots, and the method may comprise a step of determining a displacement strategy on the area of interest of the said at least two energy-autonomous robots. The displacement strategy may be used to decrease the number of robots used to treat the area of interest.

### BRIEF DESCRIPTION OF THE DRAWINGS

Many other features and advantages of the present invention will become apparent from reading the following detailed description, when considered in conjunction with the accompanying drawings, in which:

FIG. 1 is a schematic representation of a device and system according to a first embodiment of the invention;

FIG. 2 is a schematic representation of a device and system according to a second embodiment of the invention;

FIG. 3 is a schematic representation of a method according to the first embodiment of the invention;

FIG. 4 is a schematic representation of two robots over an area of interest;

FIG. 5 is a schematic representation of four robots according to the invention;

FIG. 6 is a schematic representation of three robots according to the invention; and

FIG. 7 is a schematic representation of six robots according to the invention.

### DETAILED DESCRIPTION

The embodiments described hereinafter being in no way limiting, it is possible in particular to consider variants of the invention comprising only a selection of characteristics described, subsequently isolated from the other characteristics described, if this selection of characteristics is sufficient to confer a technical advantage or to differentiate the invention from the state of the art. This selection comprises at least one characteristic, preferably functional without structural details, or with only a part of the structural details if this part only is sufficient to confer a technical advantage or to differentiate the invention from the prior art. The same reference numbers are used for identical elements or elements achieving the same function in the different embodiments of the invention that will be described.

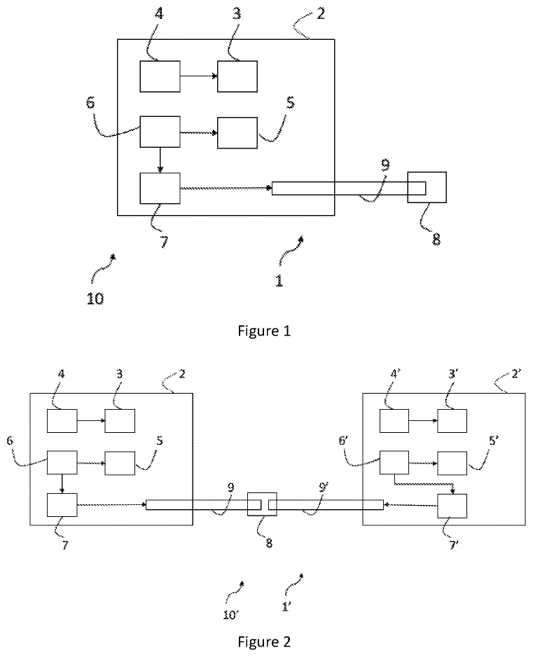

FIG. 1 represents a schematic view of a device 1 for analyzing data provided by a robot 2. The robot 2 is arranged to move on an area of interest L (FIG. 4). The robot 2 comprises a plurality of two wheels 3, each powered by an electric machine 4. According to the embodiment represented on FIG. 1, the electric machines 4 are two asynchronous motors.

The robot 2 comprises a tool 5 powered by an electric machine 6. According to the embodiment represented on FIG. 1, the robot 2 comprises a cutting module. The robot 2 comprises acquiring means 7 associated to a machine of the said at least one electric machine, the electric machine 6 according to the embodiment represented on FIG. 1.

The robot 2 also comprises a GPS receiver unit. Acquiring means 7 are located at the robot 2, and are configured for acquiring at least one item of information, corresponding to the power supply of the machine associated to the acquiring means 7, (which is the same electric machine or a different electric machine than the electric machine 4), the electric machine 6 according to the embodiment represented on FIG. 1. In the embodiment represented on FIG. 1, the at least one item of information corresponds to the current absorbed by electric machine 6. The acquiring means 7 are arranged to acquire the said at least one item of information at a frequency greater than 10 Hz.

FIG. 1 also discloses processing means 8 configured for interpreting the at least one acquired information. The processing means 8 associate a position of the robot 2 and at least one item of information. The processing means 8 are located remotely from the robot 2. FIG. 1 also discloses transmitting means 9 for transmitting the said at least one information, from robot 2 to processing means 8. For example, transmitting means 9 may comprise an emitter at the robot side and a receiver at the processing means side.

Therefore, FIG. 1 represents a device 1 according to a first embodiment of the invention wherein device 1 comprises the acquiring means 7, the transmitting means 9 and the processing means 8. FIG. 1 also discloses a system 10 according to a first embodiment of the invention, the system 10 comprising the robot 2 and the device 1 according to the first embodiment of the invention.

In a second embodiment of a device according to the invention, only described with its differences with the first embodiment of the device according to the invention, the machine 6 may comprise a stepper motor and the at least one item of information corresponds to the motor phase control signals of the said stepper motor. In a third embodiment of a device according to the invention, only described with its differences with the first or/and the second embodiments of the device according to the invention, the processing means 8 may be located at the robot 2. In a fourth embodiment of a device according to the invention, only described with its differences with the first or/and the second or/and the third embodiments of the device according to the invention, the processing means are configured for interpreting at least two items of information corresponding to the power supply of two of the at least one electric machine. In a fifth embodiment of a device according to the invention, only described with its differences with the first or/and the second or/and the third or/and the fourth embodiments of the device according to the invention, each of the machine is associated to acquiring means for acquiring at least one item of information, corresponding to the power supply of said machine.

FIG. 2 discloses a second embodiment of a system 10′ according to the invention. The system 10′ includes a first robot 2 which has been previously described. The system 10′ also includes a second robot 2′, comprising the same components as the first robot 2, which are designated by the same number of the ones of the first robot two, by adding a prime symbol. For example, the acquiring means of the second robot 2′ are numbered 7′ on FIG. 2.

Also, processing means 8 are configured for interpreting the at least one acquired information by the acquiring means 7′. The processing means 8 are located remotely from the robot 2′. FIG. 2 also discloses transmitting means 9′ for transmitting the said at least one information, from robot 2′ to the processing means 8. For example, transmitting means 9′ may comprise an emitter at the robot side and a receiver at the processing means side. Therefore, FIG. 2 represents a device 1′ according to a second embodiment of the invention wherein device 1 comprises the acquiring means 7 and 7′, the transmitting means 9 and 9′ and the processing means 8.

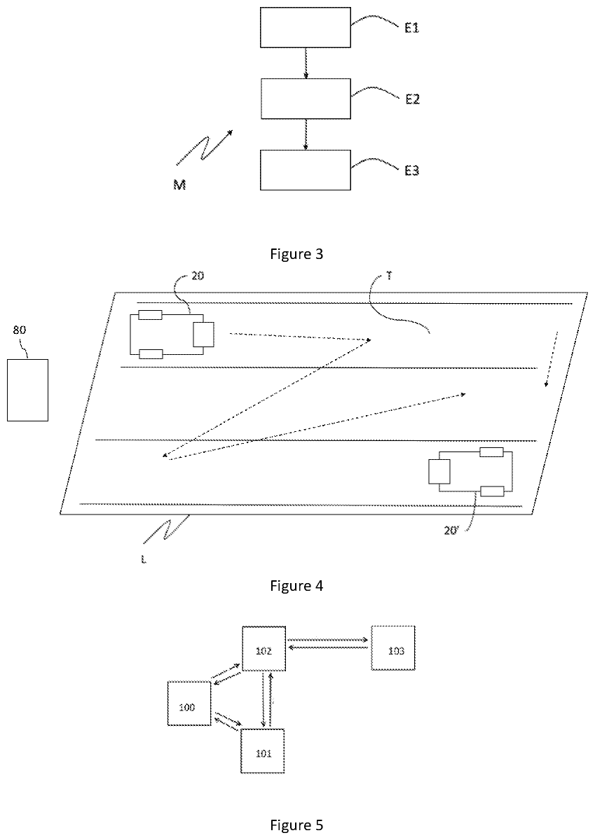

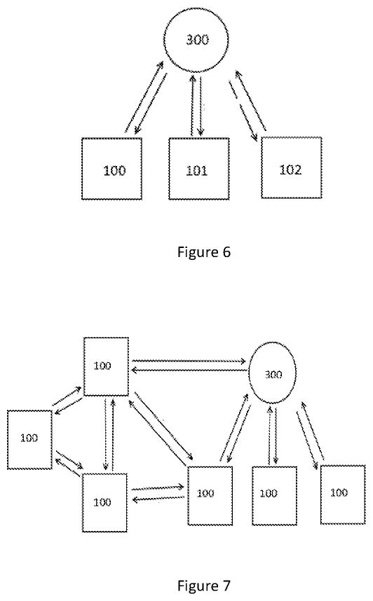

FIG. 3 is a schematic representation of a method M according to a first embodiment of the invention. Method M is a method for analyzing data provided by a robot, for example robot 2 of FIG. 2, of at least one energy autonomous robot, for example robots 2 and 2′ of FIG. 2. Method M comprises:
a step E1 of acquiring, by acquiring means associated to a machine located at the robot, for acquiring at least one item of information, corresponding to the power supply of the said machine,
a step E2 of interpreting, by processing means, the said at least one acquired information, and transmitting the said at least one information from the robot to the processing means,
a step E3 of creating a map of the area of interest L (FIG. 4) from the interpreted information and a position of the robot corresponding to the position of the robot in the area of interest where the at least one item of information has been acquired.

The map may be used to deduce characteristics of the area of interest from the at least one item of information. For example, when the robot is a mowing robot and when the at least one item of information is the power used by a cutting module of the mowing robot, and when the information is associated to the geographical position where the said power has been acquired, a map of the density of grass may be generated. The said map may be used to deduce characteristics of the area of interest.

As shown on FIG. 4, the method M may comprise a step of determining a displacement strategy T, on a processing means 80, of two robots 20 and 20. The step of determining the displacement strategy may comprise the use of a map which has been created a method according to the invention. The goal is to maximize the size of the area that a group of robots, also called machines, can cover.

When they operate on the same area, the robots know the work which has already been done and the course of each other. At a given moment, each machine has in memory all the working history of each machine working or having worked on the current zone. The future actions of robots knowing their next task or move must be written into the shared knowledge base.

Thanks to this common past/present/future memory, each robot can decide to work in a specific location knowing that no other robot, or himself, has ever been to this location and that no other robot has planned to go there immediately. It can even optimize its travel route to avoid areas already worked by others or itself. The knowledge of the future displacement of each robot also makes it possible to avoid collisions between robots.

This knowledge base requires a means of communication between robots. Robots can communicate directly with each other or via an external platform. Without an external platform, a connection mesh can then be established between each machine sharing its knowledge. A machine 100, 101, 102, 103, becomes a connection node. Each connection is bidirectional (FIG. 5).

In the case of robots which cannot directly communicate with each other, an external device 300, which might be a server, must act as a relay between the robots 100, 101 and allows a bidirectional connection between each robot and the external device. The two diagrams can be combined according to the use case, a robot can communicate with another robot, which in turn exchanges with another robot through the external device to relay the connections.

More generally, the invention relates to a method of managing a fleet of information carrier vehicles. Each of the vehicles is autonomous in energy and arranged to move and roll on a ground of a field L. Each of the information carrier vehicles comprises a tool for performing a work.

A vehicle might be a robot 2, 2′, 20, 20′, 100, 101, 102 as previously described. The tool might be the tool 5 or 5′ as previously described. The tool might be a cutting tool 5 or 5′ as previously described.

Each of the information carrier vehicles comprises data communication means for communicating data to a communicating access point common to said fleet of information carrier vehicles. The communicating access point might be the external device 300. The data communication means might be the emitter part of the transmitting means 9 or 9′ previously described.

At the vehicle level, the method comprises:
generation of data of interest,
optional step of local preprocessing of data of interest,
step of recording data of interest or pre-processed,
transmission of recorded data,
movement commands reception and applying the received movement commands.

For example, the data of interest might be acquired by the previously described acquiring means 6 or 6′. For example, the data generating means might be associated to a power consumption sensor of the work tool. The power consumption sensor might be a back EMF sensing tool.

In another embodiment, the data of interest is generated from at least one element of the group that follows:
power consumption capture device: of one or several electric machines,
image capture device,
meteorological data capture device,
hygrometry data capture device,
sunshine capture device,
device for capturing aeraulic data,
soil resistivity data capture device,
insect population counting device,
early warning device of disease,
obstacle detection device on the ground.

Another device which might be used is a device for sampling the air surrounding the vehicle. The device might comprise several gas sensors in order to analyze the sampled air. More generally, an electronic nose might be used. The device might be located on the vehicle.

In another embodiment, the device might be located in a remote location. For example, the device might be located on the field. In this case, the vehicle further comprises data communication means configured to receive data generated by said device. For example, a fixed sensor might sense the sunshine exposure and communicate the sensed data by using a Bluetooth emitter, or a BLE emitter.

The optional preprocessing step might include a step of aggregating the data of interest. The aggregation might be a temporal aggregation. For example, there the temperature might be aggregated on a temporal length of an hour. The aggregation might be a location-based aggregation. For example, there the temperature might be aggregated on an area of a radius of 2 meters. The aggregation step might be useful to save energy when transmitting the aggregated data.

The vehicle might comprise storage means of the terrain topology (for example, flooded area). The stored topology might be a complete topology of the field. The stored topology might be a partial topology of the field, for example known on a sliding period.

The method of managing a fleet of information carrier vehicles might comprise a step of receiving, at the vehicle level, one or more updates related to the field topology. The step of transmitting data of interest or pretreated might be performed synchronously, the transmission frequency being lower than said acquisition frequency, and variable depending on a local loan and/or an instruction from the server.

In another embodiment, the step of transmitting data of interest or pretreated might be performed asynchronously. The transmitting might be triggered by an event local or external to the vehicle (e.g. received from the access point). It is thus possible to control the acquisition and/or sending of local data according to the information needs calculated by the server.

At a remote level, possibly the access point 300, the method comprises:
processing received data to determine a strategy for controlling the vehicle fleet,
communication to the fleet vehicles of movement commands determined from said driving strategy.

The preprocessing step might comprise a step of associating a time stamp and a location with the data of interest. The location might be a geographical location. The geographical location might be received by a GNSS device located at the vehicle level The GNSS device might be a GPS device or a GPS RTK device. The data of interest might be generated by data generating means associated with the working tool.

At the remote level, or at the local level, the method of managing a fleet might further comprise a step of receiving data of interest from at least one other device. Such data of interest might be, for example weather data, train arrivals, or data provided by an unmanned vehicle, for example an unmanned air vehicle. The data acquisition step of interest might be implemented at a frequency between 0.1 and 20 Hz.

At the remote level, the method of managing a fleet might comprise an aggregation step of received data of interest to build profiles associated to a particular area. The method might comprise an implementation of neural networks optimizing the functions and trajectories of the robot from historical data.

For example, in a particular area of the field is very demanding in term of electric consumption of the tool (known by the power consumption capture device), it might be inferred the very important quantity of herbs are in the particular area. The strategy might be to send in this area a robot which has a very high state of battery. Another or complementary strategy might be to send several robots in this particular area.

For example, by extracting data from the obstacle detection device, the topology of the field might updated. The displacement strategy might be changed as a consequence. Other strategy might include informing robots of non-crossing zones in the field, to send commands order to the robots to prevent them from staying in an area with shadows, to go to low consumption areas to optimize battery life (use of cyclic battery consumptions).

The method of managing a fleet of information carrier might comprise a predetermination of a partition of the terrain into a plurality of sub-parcels. Each of the sub-parcels might be provided with an indicator determined from a quantity of energy consumed by the tool of the vehicles on said sub-parcel and by the time elapsed on said sub-parcel by the vehicle. The moving strategy might be to move vehicles from one sub-parcel to another sub-parcel in accordance with a decreasing sequence of the associated indicators.

The method might comprise a step of calculating, for each of the vehicles, a objective point, the said objective point being calculated by using the data of interest and/or actual geographic position of the vehicle, and a predetermined constraint. The constraint might be to optimize the overall energy used by the vehicles. The method might comprise a determination of a moving strategy, by the vehicle, from a map of workload density which is computed at the remote processing device.

Of course, the invention is not limited to the examples which have just been described and numerous adjustments can be made to these examples without departing from the scope of the invention. In addition, the various features, forms, variants and embodiments of the invention can be combined with one another in various combinations insofar as they are not incompatible or exclusive of one another. Other variations to the disclosed embodiments can be understood and effected by those skilled in the art in practicing the claimed invention, from a study of the drawings, the disclosure, and the appended claims.

1. A method comprising:
(a) managing a fleet of information carrier vehicles, each of the vehicles being autonomous in energy and arranged to move and roll on a ground of a field, each of the information carrier vehicles comprising a data communicator operably communicating data to a communicating access point common to the fleet of information carrier vehicles, and a tool for performing a work;
(b) at vehicle level:
i. generating data of interest;
ii. recording the data of interest or pre-processed, transmission of recorded data;
iii. receiving commands and applying the received movement commands;
(c) at a remote processing device for the vehicles:
i. processing received data to determine a strategy for controlling the vehicle fleet; and
ii. communicating to the fleet vehicles of movement commands determined from the driving strategy.

2. The method according to claim 1, wherein the further comprising associating a time stamp and a location with the data of interest.

3. The method according to claim 1, in which the data of interest are generated by a data generator associated with the working tool.

4. The method according to claim 1, wherein the data of interest is generated from at least one element of the group that follows:
power consumption capture device;
image capture device;
meteorological data capture device;
hygrometry data capture device;
sunshine capture device;
device for capturing aeraulic data;
soil resistivity data capture device;
insect population counting device;
early warning device of disease; or
obstacle detection device on the ground.

5. The method according to claim 1, further comprising, at the level of the vehicles, a sampler operably sampling air surrounding the vehicles.

6. The method according to claim 4, wherein the device is remote from the vehicle, the vehicle further comprising a data communicator configured to receive data generated by the device.

7. The method according to claim 1, further comprising aggregating the data of interest.

8. The method according to claim 1, wherein in the step of transmitting the data of interest is performed synchronously, asynchronously, or triggering an event local or external to the vehicle.

9. The method according to claim 1, wherein the vehicles comprise storage moans of terrain topology.

10. The method according to claim 9, wherein the stored topology is a complete topology of the field or partial topology of the field.

11. The method according to claim 10, comprising receiving, at the vehicle level, one or more updates of the topology of the vehicles.

12. The method according to claim 1, further comprising receiving data from at least one other device.

13. The method according to claim 1, comprising an aggregation of received data to build profiles associated to a particular area of the field.

14. The method according to claim 1, comprising a predetermination of a partition of the terrain into a plurality of sub-parcels, each of the sub-parcels being provided with an indicator determined from a quantity of energy consumed by the tool of the vehicles on the sub-parcel and by a time elapsed on the sub-parcel by the vehicles.

15. The method according to claim 1, comprising an implementation of neural networks optimizing functions and trajectories of a robot from historical data.

16. The method according to claim 1, comprising calculating, for each of the vehicles, an objective point, an objective point being calculated by using at least one of: the data of interest and an actual geographic position of the vehicle.

17. A method comprising:
(a) managing a fleet of information carrier vehicles, each of the vehicles being autonomous, each of the information carrier vehicles communicating data to a communicating access point common to the fleet of vehicles;
(b) at a vehicle level:
i. generating data of interest;
ii. recording the data of interest or pre-processed, transmission of recorded data;
iii. receiving commands and applying the received movement commands;
(c) at a remote vehicular processor:
i. processing received data to determine a strategy for controlling the fleet of vehicles;
ii. communicating movement commands determined from the driving strategy to the fleet of vehicles; and
(d) a determination of a moving strategy, by the vehicle, from a map of workload density which is computed at the remote processing device.

18. A system comprising a fleet of vehicles and a server, arranged for the implementation of a method comprising:
(c) managing the fleet of vehicles which are autonomous, each of the vehicles communicating data to a communicating access point common to the fleet of vehicles;
(d) at vehicle level:
i. generating data of interest;
ii. recording the data of interest or pre-processed, transmission of recorded data;
iii. receiving commands and applying the received movement commands;
(e) at a remote processing device for the fleet of vehicles:
i. processing received data to determine a strategy for controlling the fleet of vehicles; and
ii. communicating movement commands determined from the driving strategy to the fleet of vehicles.

19. The system according to claim 18, further comprising a server.
